(19) United States
(12) Patent Application Publication
(10) Pub. No.: US 2006/0152466 A1
(43) Pub. Date: Jul. 13, 2006

(54) Method of driving source driver of LCD

(75) Inventor: Hyung Kyu Kim, Kyoungki-do (KR)

Correspondence Address: SEYFARTH SHAW LLP, 55 E. MONROE STREET, SUITE 4200, CHICAGO, IL, 60603-5803, US

(73) Assignee: Boe Hydis Technology Co., Ltd.

(21) Appl. No.: 11/266,644

(22) Filed: Nov. 3, 2005

(30) Foreign Application Priority Data
Jan. 10, 2005 (KR) 10-2005-0002063

(51) Int. Cl. G09G 3/36

(52) U.S. Cl. 345/100

(57) ABSTRACT

Disclosed is a method of driving a source driver of an LCD which can reduce power consumption of the LCD by reducing the operating range of an amplifier provided on the last terminal of a source driver. According to the method, the output terminal of the source driver is kept at a specified level by connecting the output terminal of the source driver to a gamma reference voltage having a certain level among the plurality of gamma reference voltages in the standby state of the source driver. If the display data of the next frame has a voltage level of a positive region in the standby state, the output terminal of the source driver is connected to the gamma reference voltage having an intermediate level of the positive region, while if the display data of the next frame has a voltage level of a negative region in the standby state, the output terminal of the source driver is connected to the gamma reference voltage having an intermediate level of the negative region.

### BACKGROUND OF THE INVENTION

1. Field of the invention

The present invention relates to a method of driving a source driver of a liquid crystal display (LCD), and more particularly to a method of driving a source driver of an LCD which can reduce power consumption of the LCD by reducing the operating range of an amplifier provided on the last terminal of a source driver.

2. Description of the Prior Art

In general, a liquid crystal display includes a liquid crystal panel having pixels arranged in a matrix structure between a plurality of data lines driven by a source driver and a plurality of scan lines driven by a gate driver.

In such a liquid crystal display, a gate driver charges liquid crystal cells on a respective pixel with charge corresponding to display data through data lines while scan lines are in an active state, thereby illuminating the respective pixel.

In line with this, a conventional source driver receives RGB data from a timing control device and stores the received RGB data as display data. Then, the source driver assigns voltage values to the respective display data using a gamma reference voltage according to gradation levels. The display data created by the source driver is applied to the liquid crystal cells with its polarity changed for each frame in accordance with a polarity signal inputted to the source driver.

The conventional source driver as described above uses a charge sharing (CS) mode to reduce power consumption when the display data is applied to the liquid crystal cell.

FIG. 1 is a waveform diagram explaining a CS mode used in the conventional source driver.

As shown in FIG. 1, the CS mode maintains an output level at an intermediate level between a liquid crystal driving voltage level and a ground level in a standby state (a) until the next display data is outputted after the actual output time of the source driver elapses. Accordingly, when the level of the display data outputted from the source driver is changed from positive region A to negative region B and vice versa, the change width of the voltage level is shortened and thus the power consumption can be reduced.

However, the degree of power reduction according to the conventional technique in which the source driver adopts the CS mode cannot fully satisfy consumer's demands for reduction of power consumption in the liquid crystal display.

### SUMMARY OF THE INVENTION

Accordingly, the present invention has been made to solve the above-mentioned problems occurring in the prior art, and an object of the present invention is to provide a method of driving a source driver of an LCD which can minimize power consumption of the LCD by reducing the change width of the voltage level when display data is outputted by adjusting the voltage level in a standby state of the source driver.

In order to accomplish this object, there is provided a method of driving a source driver of an LCD which receives a plurality of gamma reference voltages having polarity and different levels, outputs display data with its polarity changed for each frame, and operates in a standby state in which no display data is outputted when display data of the next frame is outputted in the present frame, according to the present invention, which includes the step of keeping the output terminal at a specified level by connecting the output terminal of the source driver to a gamma reference voltage having a certain level among the plurality of gamma reference voltages in the standby state of the source driver.

In another aspect of the present invention, if the display data of the next frame has a voltage level of a positive region in the standby state, the output terminal of the source driver is connected to the gamma reference voltage having an intermediate level of the positive region, while if the display data of the next frame has a voltage level of a negative region in the standby state, the output terminal of the source driver is connected to the gamma reference voltage having an intermediate level of the negative region.

### BRIEF DESCRIPTION OF THE DRAWINGS

The above and other objects, features and advantages of the present invention will be more apparent from the following detailed description taken in conjunction with the accompanying drawings, in which:

FIG. 1 is a waveform diagram explaining a CS mode used in a conventional source driver;

FIG. 2 is a block diagram of a source driver according to an embodiment of the present invention;

FIG. 3 is a waveform diagram of control signals inputted to the source driver according to an embodiment of the present invention; and

FIG. 4 is waveform diagram of an output of the source driver according to an embodiment of the present invention.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

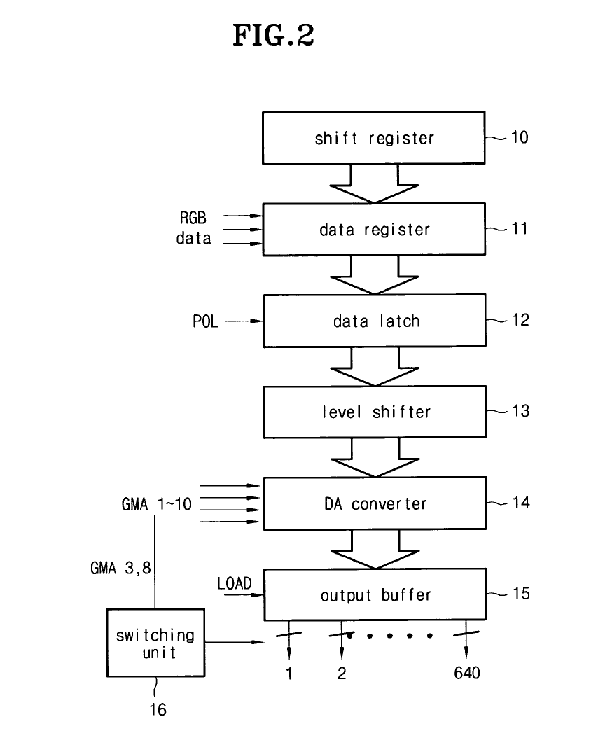

FIG. 2 is a block diagram of a source driver according to an embodiment of the present invention.

The source driver of the embodiment includes a shift register 10, a data register 11, a data latch 12, a level shifter 13, a DA converter 15, an output buffer 15, and a switching unit 16.

The shift register 10 supplies an edge sampling clock to the data register 11, and the data register 11 loads RGB data supplied from a timing control unit (not shown) in accordance with the edge sampling clock outputted from the shift register 10. Then, the RGB data is stored as whole display data of one horizontal line and is shifted to the data latch 12 receiving polarity signal POL.

The DA converter 14 receives the display data and gamma reference voltages GMA1 to GMA10, and assigns a voltage value to the respective display data using the gamma reference voltages GMA1 to GMA10 in accordance with gradation levels.

The output buffer 15 is composed of an operational amplifier for driving a liquid crystal panel, and applies the display data to a liquid crystal cell if a data output control pulse LOAD is enabled.

The switching unit 16 receives the gamma reference voltages GMA3 and GMA8, and selectively connects the gamma reference voltages GMA3 and GMA8 to an output terminal of the output buffer 15.

The source driver configured as described above creates the display data with its polarity changed for each frame in accordance to the input polarity signal POL, and is synchronized with the output control signal LOAD to apply the display data to the liquid crystal cells. Also, the source driver is in a standby state in which the display data is not outputted if the output control pulse LOAD is not inputted. At that time, the switching unit 16 selectively connects the gamma reference voltage GMA3 or GMA8 to the output terminal of the source driver, and maintains the voltage level of the output terminal as the gamma reference voltage GMA3 or GMA8.

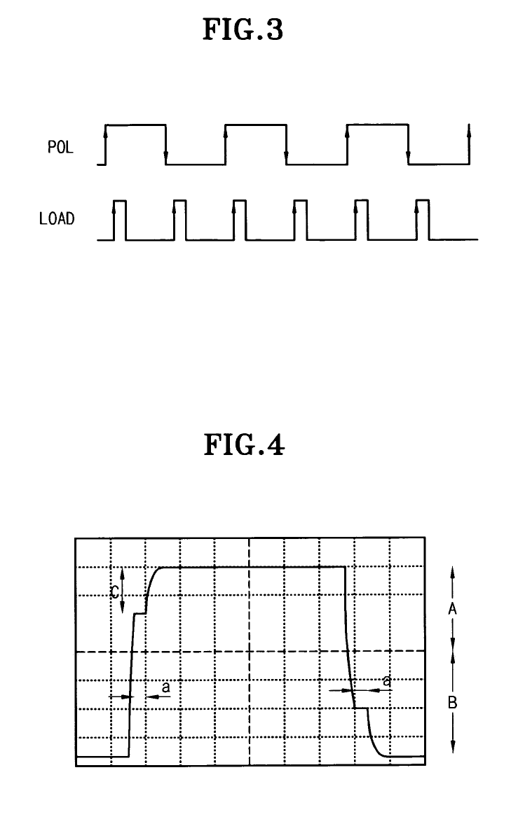

Considering operation of the source driver according to the embodiment with reference to FIGS. 2 and 3, the polarity of the display data is altered in accordance with the input timing of the output control pulse LOAD inputted to the output buffer 15, while the polarity signal POL inputted to the data register 11 is inputted in the form of a pulse. More specifically, if the output control pulse LOAD is enabled as a high level in a high level region of the polarity signal POL, the display data outputted to the source driver has a positive value. On the contrary, if the output control pulse LOAD is enabled as the high level in a low level region of the polarity signal POL, the display data outputted to the source driver has a negative value.

As described above, the source driver outputs the display data of the positive or negative region for each frame, and selectively connects the gamma reference voltage GMA3 or GMA8 to the output terminal of the source driver via the switching unit 16 in the standby state until the display data having opposite polarity is outputted. Here, the voltage level of the gamma reference voltage GMA8 is the intermediate level of the negative region and the voltage level of the gamma reference voltage GMA3 is the intermediate level of the positive region.

In case the source driver outputs the display data of the positive region and is in the standby state, the switching unit 16 connects the gamma reference voltage GMA8 to the output terminal of the source driver. That is, the voltage level outputted from the output terminal of the source driver is shifted to the intermediate level of the negative region to minimize the change width of the voltage level when display data of the next negative region is outputted.

In case the source driver outputs the display data of the negative region and is in the standby state, the switching unit 16 connects the gamma reference voltage GMA3 to the output terminal of the source driver. This is to shift the voltage level outputted from the output terminal of the source driver to the intermediate level of the positive region, contrary to the case in which the gamma reference voltage GMA8 is connected to the output terminal of the source driver.

FIG. 4 is a waveform diagram of an output of the source driver according to an embodiment of the present invention.

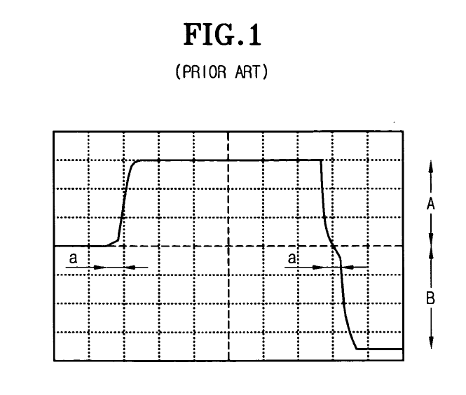

As shown in FIG. 4, the output level is maintained in an intermediate level of positive region A or negative region B in a standby state (a) until the next display data is outputted after the actual output time of the source driver elapses. Accordingly, when the display data outputted from the source driver is changed from the level of positive region A to the level of negative region B and vice versa, the change width of the voltage level is shortened by a region C to minimize the operating range of the output buffer 15 provided in the source driver. As described above, the minimized change width of the voltage level reduces the operating range of the output buffer 15 to a half, thereby effectively reducing power consumption in comparison to the CS mode used in the conventional source driver shown in FIG. 1.

Consequently, the present invention shortens the charging time of the liquid crystal cell by setting a charge start point of the liquid crystal cell as an intermediate level as well as reduces the power consumption. In addition, it is expected that the delay of the display data waveform outputted from the source driver due to the resistance and parasitic component of the liquid crystal panel can be inhibited.

As described above, according to the present invention, the output terminal of the source driver is connected to a gamma reference voltage in a standby state of the source driver, and thus the reduction of power consumption, improvement of the response speed according to the shortened charging time of the liquid crystal cells, and inhabitation of the delay of display data outputted from the source driver can be achieved.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method of driving a source driver of an LCD which receives a plurality of gamma reference voltages having polarity and different levels, outputs display data with its polarity changed for each frame, and operates in a standby state in which no display data is outputted when display data of the next frame is outputted in the present frame, the method comprising the step of:
keeping the output terminal at a specified level by connecting an output terminal of the source driver to a gamma reference voltage having a certain level among the plurality of gamma reference voltages in the standby state of the source driver.

2. The method as claimed in claim 1, wherein if the display data of the next frame has a voltage level of a positive region in the standby state, the output terminal of the source driver is connected to the gamma reference voltage having an intermediate level of the positive region; and
if the display data of the next frame has a voltage level of a negative region in the standby state, the output terminal of the source driver is connected to the gamma reference voltage having an intermediate level of the negative region.
